(19) United States
(12) Patent Application Publication
(10) Pub. No.: US 2015/0338050 A1
(43) Pub. Date: Nov. 26, 2015

(54) Device for Accessorizing Lamp Shades

(71) Applicant: Michael K. Thomas, Hot Springs, AR (US)

(72) Inventor: Michael K. Thomas, Hot Springs, AR (US)

(21) Appl. No.: 14/282,168

(22) Filed: May 20, 2014

(51) Int. Cl. F21V 1/00; F21V 17/10

(52) U.S. Cl. CPC F21V 1/00; F21V 17/105

(57) ABSTRACT

A device for permitting the securing of an overlay about a lamp shade in order to effect a change in decor, comprising a front and rear translucent panel which fit against the rear and front of a lamp shade, wherein the front panel is divided into two parallel panels which are liftable to place an overlay securely there within and having magnets to hold front and rear panels against the overlay to hold it in position about the lamp shade.

The present invention relates in a general sense, to household accessories, and more particularly devices for accessorizing lamp shades.

### BACKGROUND OF THE INVENTION

1. Field of the Invention

Whether one is moving into a new residence, or having lived in the same residence, it is human nature to seek new or different surroundings. The purchase of new furniture, for example, is often beyond the means of most residents, and people look at what they can get that will give them a fresh outlook.

Whether one is living in a single room, or multiple rooms, it is most likely that somewhere within reach is a lamp or lighting fixture having a shade.

Shades, of course, come in myriad colors and designs ranging from drab to spectacular. Even a most spectacular shade can wear on a person, and they might find it refreshing and even stimulating to make a change. It is easily recognized that changing a lampshade is vastly different from changing practically any other thing in the residence. Thus, in even the most financially challenged household, changing a lampshade may not put an undue strain on one's budget.

The task of changing a lamp shade is not without its complexities, however. Shades come in all sorts of shapes and sizes, usually intended to fit a particular lamp or lighting device, and one cannot always get the exact pattern and shape that fits a particular lighting device for which a change is sought.

How then can the task be accomplished with a minimum of time and cost expended? Forthcoming is one novel answer.

2. Overview of Related Art

When one thinks of changing a lampshade, it is usually considered to be accomplished by replacing the entire shade. That includes, of course, the frame which holds the shade in itself. Thus, the seeker will have to consider shape and size, as well as the covering and, thus, materially increases the effort in terms of time spent and even money to accomplish the task. It is for that reason that many decide to forget it and live with what has become monotony.

In order to change the covering itself, one must consider that fastened or glued in place, and to replace it on essentially a wire or plastic frame, involves an amount of time and effort which literally discourages folks from trying it. A few brave souls have, however, recognized this dilemma which a homemaker faces and have attempted to do something about it.

An example of what has gone before is found in Mann U.S. Pat. No. 4,268,896. Mann suggests a pair of what are essentially paperclips, separated by a crossbar with sides of the lampshade. They then fit under the paperclips. Mr. Sawyer has been issued U.S. Pat. No. 6,010,235 which uses a ferromagnetic plate on one side of the shade and magnets on the other side of a decorative panel.

Others, such as Throckmorton, et al., U.S. Pat. No. 4,068,120, and Glendmyer, U.S. Pat. No. 5,662,412, are not relevant in that they attach permanently to the lamp shade, Throckmorton by chemical welding and Glendmyer by the use of Velcro. The patents to Gluschkin, U.S. Pat. No. 3,456,106; Steir, et al., U.S. Pat. No. 7,314,293; Ziegler, U.S. Pat. No. 6,113,249, and Myland, et al., U.S. Pat. No. 5,121,312, are merely exemplars of what others have attempted to do in what is perceived to be nonrelevant ways of altering one's decor.

### SUMMARY OF THE INVENTION

The present invention offers to the homemaker a simple and inexpensive means of changing, or at least altering, the decor of one's residence in such a way that such changes can be made in minutes and as frequently or infrequently as one may desire.

It is another objective of the present invention to provide for such changes to be accomplished without resort to tools or any professional help whatsoever

Still a further objective is to accomplish the goals of the invention with a device which is translucent, and as such, does not interfere, in any way, with the image intended to be created by a particular change in decor. It is yet another, and still further, objective the present invention to provide, in accomplishing the objectives attributable to it, to make a change without leaving any permanent marks, stains or other blemishes which might otherwise detract from the change in decor.

The foregoing, as well as other objectives and advantages of the present invention will become apparent to those skilled in the art upon a reading of a detailed description of a preferred embodiment taken in conjunction with the included, drawings, wherein:

### DESCRIPTION THE APPENDED DRAWINGS

FIG. 1 is a pictorial representation of the device of the present invention which is responsible for positioning and holding a panel which results in a change in the decor of a lampshade;

FIG. 2 is a front side elevation of the device of FIG. 1;

FIG. 3 illustrates an exemplary lampshade having a decorative panel circumscribing the shade and being held in place by the device of FIG. 1;

FIG. 4 is an enlarged, partially sectioned portion of an exemplary lampshade, showing the device of FIG. 1 being positioned thereon;

FIG. 5 is an enlarged, partially sectioned portion of an exemplary lampshade positioned as seen in FIG. 4, with a portion of the device of FIG. 1 being elevated to permit placement of the decorative panel thereon;

FIG. 6 is a partial sectional view from the top of the lampshade of FIG. 3, illustrating the device of FIG. 1 positioned thereon;

FIGS. 7 and 8 are views similar to FIG. 6, showing the partial panels of the device of FIG. 1, in their open position and closed position, respectively;

FIG. 9 is a front side elevation in the nature of FIG. 2, illustrating the location of FIG. 10; and,

FIG. 10 is a view similar to FIGS. 6 through 8, once again illustrating the partial panels in their open position.

### DETAILED DESCRIPTION OF A PREFERRED EMBODIMENT

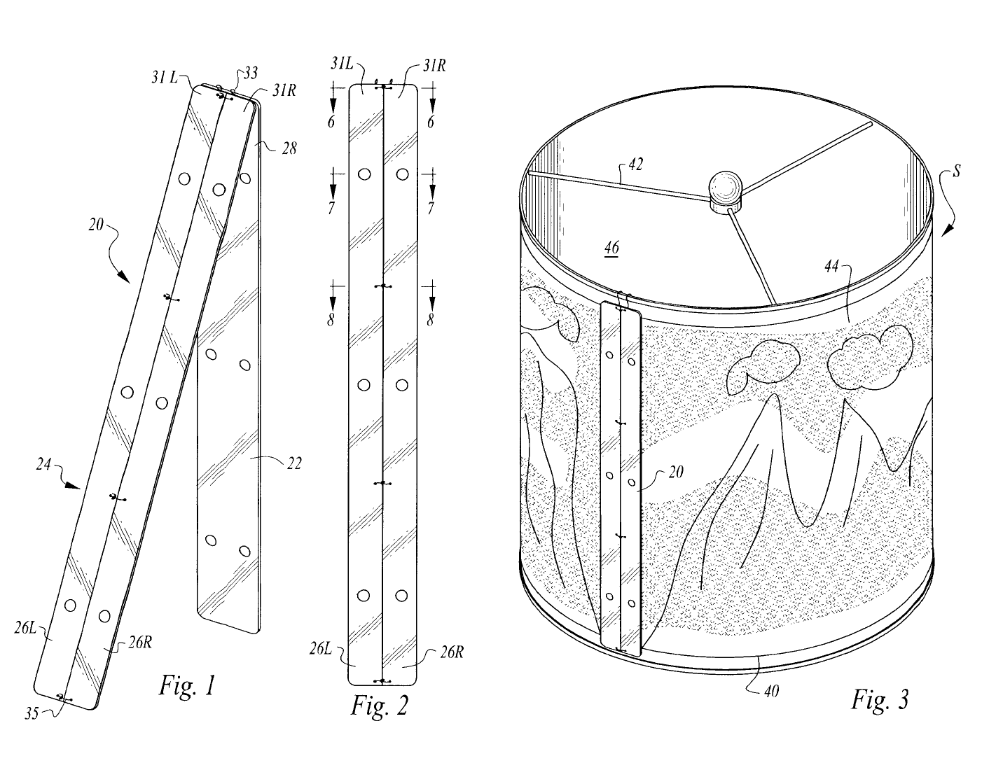

With reference now to the drawings, and initially to FIG. 1, an essential feature of the present invention is represented by a holder 20. The holder is comprised of a series of opposed translucent, elongated panels, the first of which being a rear panel 22 which is designed to rest on the inner surface of a lampshade. A second front panel, or forward panel is shown at 24. The front panel is divided into two longitudinally extending, parallel subpanel sections 26L, which is on the left and 26R, which is on the right. The left and right panels are separated along a central longitudinal, essentially vertical axis and are intended to grace the outer surface of the lampshade lying flat against the surface thereof.

The front panel and rear panel are 10 hingeably tied to one another at their top most region 31 of each. The front panel is divided into left and right subpanels, and are hingeably connected to one another, preferably in at least two places along their adjacent edges 37L and 37R. At the top 28 of the rear panel 22 and the tops, respectively, 31L and 31R, of the panels 26L and 26R are tied and joined at the rear panel 22 and the front panel sections 26L and 26R. The tie 33 itself is translucent, making the holder 20 as transparent as possible throughout and sufficiently flexible as to permit the front and rear panels 22 and 24, respectively, to achieve limited moveablity relative to one another and from one another by a very small amount. Further, a tie 35 joins the lower most position of the panel elements 26L and 26R and is of the same, or similar, material and flexibility as is found in tie 33. It will be appreciated that the tie 33 could be eliminated entirely should one wish to do so. By securing the rear panel 22 to the inside of the lamp shade, the magnets 55 would hold the rear panel 24 without the tie being used. Indeed, it would not be absolutely necessary to secure the front panel 22 permanently, but it would make it somewhat more difficult to be sure that the front and rear panels 22 and 24, respectively, are aligned so that the magnets 55 would be effective in holding the rear panel 24, again, without the tie 33.

The holder 20, in accordance with the invention, functions in concert with a lamp shade S, which includes a cover 40 circumscribing a wire frame 42. While the specific shape of the lamp shade S, in FIG. 3, is conical, in practice, it may be any of several commercial shapes, including rectangular and conical, for example.

It is an essential function of the present invention to provide a homemaker with a decorative change in decor from time to time as may be desired. In order to accomplish such a change, the lamp shade itself is provided with an overlay 44, having ends 44L and 44R, of a decorative, yet translucent, material upon which any one of several designs of a decorative nature is placed. For example, a flag design on patriotic holidays might be one such overlay; designs for the Thanksgiving, Christmas and New Year holidays; mountain and/or desert scenes and stars, as well as anniversaries and birthdays, and so on.

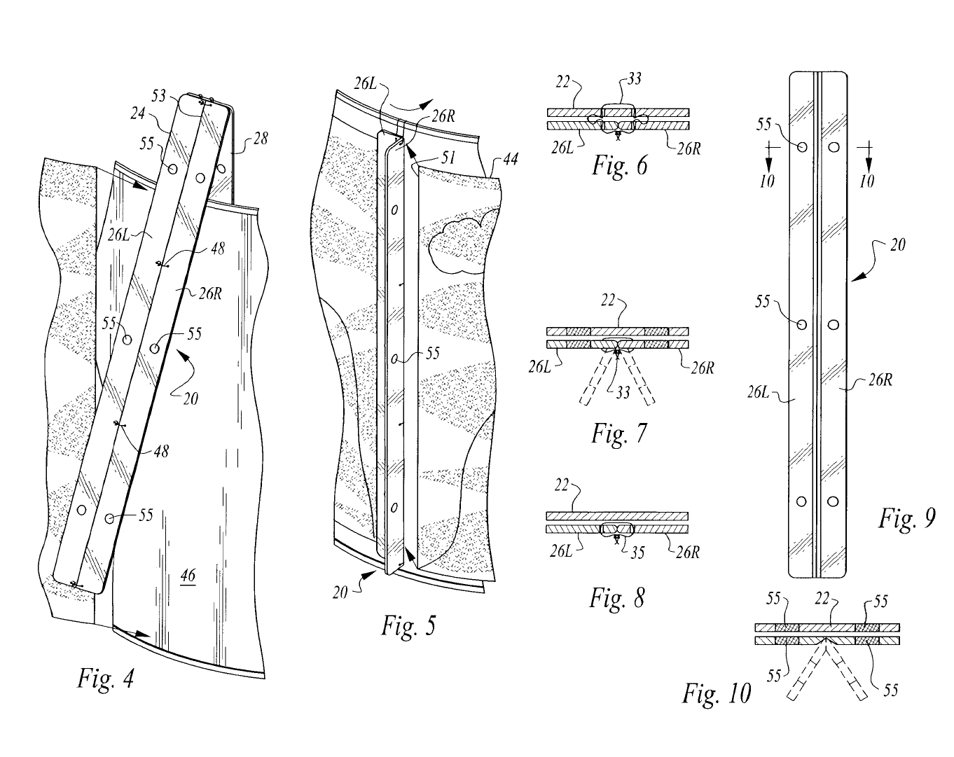

The holder 20 is expressly designed to achieve the objectives of the present invention by selectively securing the overlay 44 about the lamp shade S. This is accomplished as best seen in FIGS. 4 through 10 by means of the holder 20 as it is fitted over the lamp shade S, as best seen in FIGS. 3 and 4, where the rear panel 28 is positioned against the inner surface 46 of the lamp shade S, and is aligned with the front panel 24 which is fitted against the front, or outer, surface 48 of the lamp shade S.

The panels 26L and 26R are, as seen in FIG. 4 and elsewhere, loosely connected by translucent ties 48, 50 so that while one of the panels remains flat against the lamp shade, the other may be independently rotated outwardly as seen in FIG. 5. In so doing, the edge 51 of an overlay 44 may then be fitted against the edge 53 of the panel which remains flat against the shade. In order to hold the panels against one another front and rear, at least one, but preferably a series of magnets 55 are strategically positioned on the panels such that when the panels are flat against the lamp shade S, the north pole of the magnets on one of the panels is attracted to, and in holding position with, the south pole of the magnets 55 on the opposite panel. In this manner the edge 51 of the overlay 44 becomes secure against the lamp shade S. The opposite edge of the overlay is then secured in the same manner, with the resulting overlay completely circumscribing the lamp shade S with the design on the overlay becoming the change in decor.

It will now be evident to those skilled in the art that any number of overlays may be quickly secured about a lamp shade without the use of tools, or leaving any marks whatsoever on the overlay which, when removed, can be stored for use once again as desired.

It will be appreciated as well by those skilled in the art upon reading this detailed description may think of some variations in structure and form, such variations are within the contemplation of the invention as described and claimed in the following:

1. A holder for positioning and releasably securing an overlay circumscribing a lamp shade, comprising:
a front panel, said front panel adapted to be positioned on the outer surface of the lamp shade;
a rear panel, said rear panel being adaptable to be positioned on the inner surface of the lamp shade;
said front panel and said rear panel being aligned with one another, said front panel being liftable to engage the respective ends of said overlay and hold said overlay in position about said lamp shade.

2. The holder of claim 1, wherein said front panel being divided into subpanels, said subpanels being hingeably and linkably connected to one another, each of said subpanels being independently liftable to engage and hold said overlay and the other subpanel being liftable to engage and hold the other end of said overlay.

3. The holder of claim 2, wherein each of said panels having at least one magnet embedded therein; said magnets in said front panel being magnetically attracted to said magnets in said rear panel, said left subpanel being liftable to receive, with a lamp shade, one end of an overlay and said right subpanel being liftable to hold the other end of the overlay against the lamp shade to thereby releasably secure the overlay against the lamp shade.

4. The holder of claim 2, wherein said subpanels being separated along a longitudinal axis of said front panel.

5. The holder of claim 4, wherein said subpanels having a series of magnets located thereon, each said magnet being aligned with a companion magnet on said rear panel, the magnets being mutually attracted to hold said front panel and said rear panel in alignment and hold against the lamp shade.

6. The holder of claim 1, wherein said front panel and said rear panel being hingeably connected at the top most portion thereof.

7. The holder of claim 1, wherein each of said panels having at least one magnet embedded therein; said magnets in said front panel being magnetically attracted to said magnets in said rear panel, said left subpanel being liftable to receive, with a lamp shade, one end of an overlay and said right subpanel being liftable to hold the other end of the overlay against the lamp shade to thereby releasably secure the overlay against the lamp shade.

8. The holder of claim 3, wherein said subpanels being separated along a longitudinal axis of said front panel.

9. The holder of claim 6, wherein each of said panels having at least one magnet embedded therein; said magnets in said front panel being magnetically attracted to said magnets in said rear panel, said left subpanel being liftable to receive, with a lamp shade, one end of an overlay and said right subpanel being liftable to hold the other end of the overlay against the lamp shade to thereby releasably secure the overlay against the lamp shade.

10. The holder of claim 3, wherein said subpanels having a series of magnets located thereon, each said magnet being aligned with a companion magnet on said rear panel, the magnets being mutually attracted to hold said front panel and said rear panel in alignment and hold against the lamp shade.
